(19) United States
(12) Patent Application Publication
(10) Pub. No.: US 2003/0152185 A1
(43) Pub. Date: Aug. 14, 2003

(54) Catalasan nuclear fusion reactor a rotating centrifugal-laser nuclear fusion reactor

(76) Inventor: Peter Paul M. Catalasan, Harbor City, CA (US)

Correspondence Address: Peter Paul M. Catalasan, 25410 Dodge # K, Harbor City, CA, 90710, US

(21) Appl. No.: 10/074,935

(22) Filed: Feb. 14, 2002

(51) Int. Cl. G21B 1/00; G21J 1/00

(52) U.S. Cl. 376/107

(57) ABSTRACT

Generations of Physicists have attempted to build Thermonuclear Fusion Reactors in hope of harnessing the power of the ubiquities Hydrogen and Hydrogen to Helium Reaction. The failure, I believe, involves overcomplicated design structures such as plasma, needing total electromagnetic confinement! Being an educated physicist myself from the University of California at Riverside and with all due respect to scientists, as Einstein once said, “Keep it simple stupid,” is a guiding phenomenon in all of physics. Thus, I have chosen my design as a very practical Rotating Centrifugal-Laser Nuclear Fusion Reactor, a design without plasma and involve using a high-speed centrifugal-laser Hydrogen containment fusion reactor.

### TABLE OF CONTENTS

I. Field of Invention

II. Summary of Invention

III. Brief Description of Drawings

IV. Description of the preferred Embodiments

V. System Drawings

I. Field of Invention

The field of invention encompasses Mechanics, Thermodynamics, Solid State Physics, and Particle and Laser Physics. However, the actual comprehension of the design can also be understood in a simple way using appropriate drawings.

II. Summary of Invention

The idea of my invention is to use a large high-speed centrifugal rotating Disk with many Lasers attached at the ends of the Disk in a circular fashion in order to confine two positively charged Hydrogen atoms for each and every Laser, where the force of the laser and the force of the centrifuge are in opposite equilibrium making the two protons “sit still,” and with a cylindrical electromagnetic confinement, in order to guide the two protons into a cross section, using this circular electromagnetic field confinement, so that the two high temperature proton particles heated by the laser does not melt the disk. The material of the disk requires that it act as a good heat sink and strong enough to overcome high speed stress and strain when rotating.

### III. BRIEF DESCRIPTION OF THE DRAWINGS

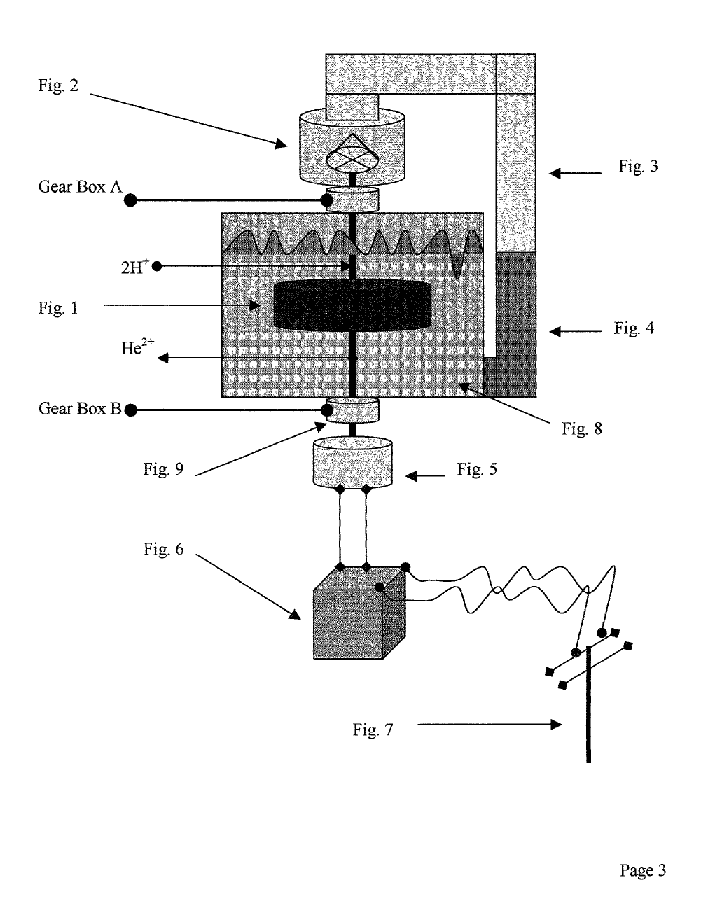

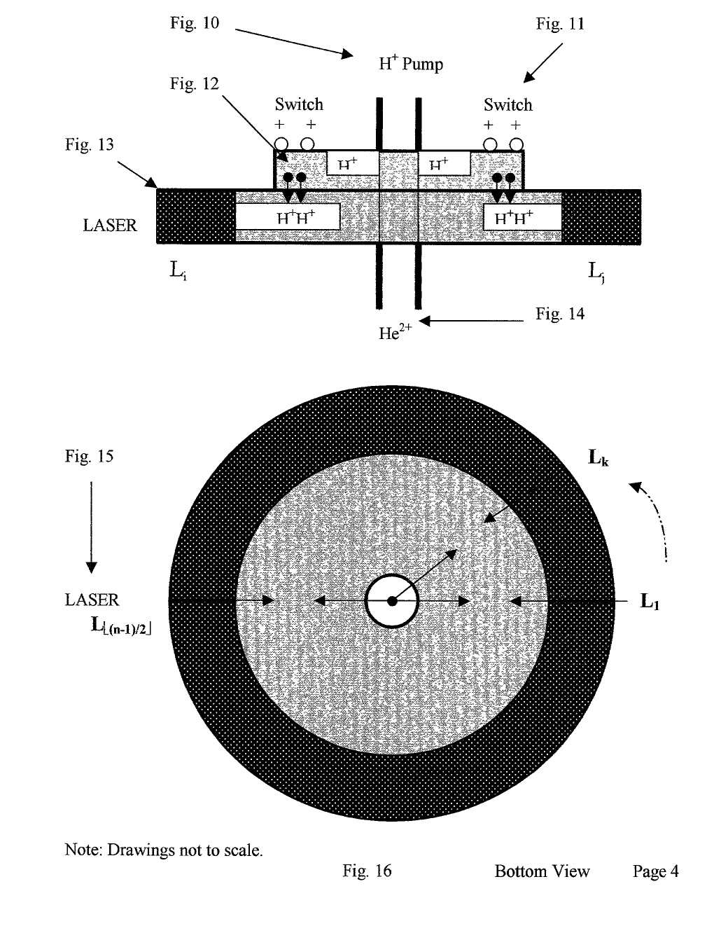

The Catalasan Nuclear Fusion Reactor consists of a Disk, FIG. 1, a high-speed rotating centrifugal-laser nuclear fusion reactor. Moreover, it can use a traditional fluids, FIG. 4 & FIG. 8, that is heated by the Disk, FIG. 1, to create a steam, FIG. 3, that powers fan blades, FIG. 2, in order to spin the Disk, with inputs of 2H⁺ and outputs of He²⁺. The two Gear Boxes, A and B, FIG. 9 & FIG. 10, enhance the spin of the Disk for higher and variable speeds of rotation.

To begin to start the entire fusion reactor, there must be a Starter, FIG. 5, an electro-mechanical motor that spins the Disk using a rechargeable Battery, FIG. 6. Once, the system is running, the Starter becomes a Charger, FIG. 5, with Gear Box B, FIG. 9, in order to charge the Battery, FIG. 6, connected to a power line, FIG. 7, for electrical consumption. The Disk, FIG. 1, is a high-speed centrifugal-laser fusion reactor explained on the Drawing Pages as a Cross Section Diagram of the Disk, FIG. 1. It consists of a series of Lasers, FIG. 13, attached at the ends of the Disk. The input of protons by a pump, FIG. 10, causes an input of H⁺ & H⁺ by a Switch, FIG. 11, from FIG. 12, into the Laser-Centrifuge. Once the H⁺ & H⁺ form He²⁺, the He²⁺ has a positive charge and lesser mass; He²⁺ falls out, FIG. 14. The Bottom View is specified in FIG. 16, with Lasers, FIG. 15.

### IV. DESCRIPTION OF THE PREFERRED EMBODIMENTS

The Overall System Model, or the Catalasan Centrifugal-Laser Nuclear Fusion Reactor, Drawing Pages, consist of the Rotating Disk, FIG. 1, Fan Blades, FIG. 2, Steam, FIG. 3, Fluid, FIG. 4 & FIG. 8, Gear Box A & B, FIG. 9, Starter or Charger, FIG. 5, Battery, FIG. 6, and Electrical Consumption, FIG. 7

The Rotating Disk, FIG. 1, is the primary source of heat from nuclear reactions to raise the temperature of the Fluid, FIG. 8, to produce Steam, FIG. 3, in order to spin the Fan Blades, FIG. 2, making the Disk System spin. The Disk must be a good heat sink in order to transfer the heat energy into its surrounding Fluid, FIG. 8.

The Fan Blades, FIG. 2, through Steam, FIG. 3, power the Disk System much like a Nuclear Fission Reactor.

The Steam, FIG. 3, causes the Fan Blades, FIG. 2, to Spin, connected to a Gear Box A for variable speeds as needed according to centrifugal-laser equilibrium requirements.

The Fluid FIG. 4 & FIG. 8, is regular H₂O so that this Nuclear Fusion Reactor will be safe to Human Environments.

The Gear Box A & B, FIG. 9, provide a means of automatic control to accelerate and decelerate the Disk System between the Fan Blades, FIG. 2, and Starter and Charger, FIG. 5.

The Starter or Charger, FIG. 5, is an Electric Motor for starting the Fusion Reactor and a Charger once the Reactor is up and running.

The Battery, FIG. 6, is needed to start the Fusion Reactor and once started becomes a rechargeable storage for electricity.

The Electrical Consumption, FIG. 7, is a power line for commercial consumption.

The Rotating Disk, in the Drawing Pages, displayed as a Cross Section of the Disk, consist of the Proton Pump, FIG. 10, Electrical Switch, FIG. 11, Proton Transfer, FIG. 12, Disk Laser, FIG. 13, and Helium Release, FIG. 14.

The Proton Pump, FIG. 10, pushes protons into the top level of the Disk.

The Electrical Switch, FIG. 11, toggles between zero and a positive charge in order to transfer protons into the bottom level of the Disk.

The Proton Transfer, FIG. 12, are two holes between the top level and bottom level of the Disk to transfer protons by an electrical switch, FIG. 11.

The Disk Lasers, FIG. 13, are lasers attached at the ends of the Disk to provide equilibrium to two protons when under centrifugal forces by Disk rotation and Laser momentum, for each and every Laser.

The Helium Release, FIG. 14, after the two protons fuse into Helium by the heat produced by the Disk Lasers, it pushes the Helium out since it has two positive charges and lighter than the two protons. Then, it repeats this process again.

Please note that I have described only one Laser Model and that there are several Lasers attached at the ends of the Disk in circular formation. Also, not shown in the Diagrams, there is a simple Circular Electromagnetic Field Confinement so that the two protons do not touch the material Disk System at the bottom level in order not to melt the Disk.

Moreover, the Fusion Reactor can have multiple Disks, stacked flip-flopped on top of each other for more fusion power when appropriately needed. And, for uses in Space, one requires a counter rotation mechanism not mentioned in this Patent Application; quite similar in fact to so-called “fictitious” UFOs.

The practical Design of this Fusion engine is its simplicity, ease of use, and safety far better than Nuclear Fission Reactors, free from harmful radiation. And, since it is without complex plasma, the simplicity of this Reactor makes Maintenance far better than any Nuclear Fusion Reactor Design. It also has a direct rotating axel to the Fan Blades, FIG. 2, and Electric Motor, FIG. 5. Considering the military uses of this Reactor, it can never be used for weapons of mass destruction. Moreover, using high-pressure water and steam makes this Nuclear Fusion Reactor so environmentally friendly that I believe this design merits praise and reward to all people across the world.

This Work is dedicated to my Most Intelligent Brother, Manolito Catalasan, who invited Peter Paul Catalasan to study Physics at the University of California at Riverside, upon which Peter Paul became the first to discover Unlimited Energy through Matter/Antimatter Production/Separation.

Having the knowledge of Unlimited Energy, we can apply such energies to overcome long distances through the use of Einstein's properties of Relativity upon which many equations have negative time dependency related to the speed of light. For example, if it takes one million light-years to get to another Galaxy, why not go back in time for one million light-years while traveling there, therefore arriving at t=0.

Given this opportunity, and a coordinated research effort between Valentino Catalasan, Victor Catalasan, and Peter Paul Catalasan, we can form an Advanced Research Laboratory, called the Advanced Catalasan Research Laboratory, Inc, or ACRL, which will spin off to a committed effort for any Noble Research Activity, where Manolito, as Chief Executive Officer, will own the Research Information. The responsibilities of research and development come from Valentino Catalasan—Chief Technology Officer, Peter Paul Catalasan—Research Director, and Victor Catalasan—Engineering Physicist. We all have Techhnological First Loves, Computer Science for Valentino, Physics for Peter Paul, Engineering for Victor, and the Last Star Fighter Austin Catalasan.

Catalasan Nuclear Fusion Reactor Current Claims are as follows:

1. Thermonuclear Fusion Reactor

2. Electrical Energy Generation Plant

3. Submarine Power Plant

4. Spacecraft Power Plant

5. Commercial Power Plant
